(19) United States
(12) Patent Application Publication
(10) Pub. No.: US 2007/0224417 A1
(43) Pub. Date: Sep. 27, 2007

(54) Process for manufacturing a breathable thermoadhesive transfer, for application onto a fabric or onto other materials, and a breathable thermoadhesive transfer obtained

(76) Inventor: Emanuele Acatti, Milano (IT)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,875

(22) Filed: Feb. 26, 2007

Related U.S. Application Data
(60) Provisional application No. 60/791,731, filed on Apr. 13, 2006.

(30) Foreign Application Priority Data
Mar. 9, 2006 (IT) MI2006A000419

(51) Int. Cl. B32B 27/04; B32B 7/12; B29C 35/08

(52) U.S. Cl. 428/343; 442/149; 264/400

(57) ABSTRACT

A process is described for manufacturing a breathable thermoadhesive transfer, for instance suitable for application onto a fabric, in which a step of processing using laser technology to create holes in said thermoadhesive transfer is carried out before the application step.

### CROSS REFERENCE TO RELATED APPLICATIONS

This application claims priority under 35 U.S.C. Section 119(e) to U.S. Provisional Application 60/791,731, filed on Apr. 13, 2006.

### BACKGROUND OF THE INVENTION

1. Field of the Invention

The present invention refers to a process for manufacturing a breathable thermoadhesive transfer, for application onto a fabric or onto other materials, and a breathable thermoadhesive transfer obtained.

2. Description of the Prior Art

In recent years the clothing manufacturing industry has paid particular attention to the use and development of so-called ‘technical’ fibres and/or fabrics.

In particular in the sportswear sector, fabrics that are capable of ‘helping’ athletes improve their performance in sports activities have been developed.

Among the various requirements for sportswear, particular attention has been given to developing extremely lightweight and/or breathable fabrics.

Articles of clothing often feature graphic designs, lettering, logos and decorations in general that help to improve the look of the garment and/or convey an advertising message, represent a logo, a concept, etc.

Various printing techniques are used to customize garments, depending, for example, on the type of fabric, the desired end result, etc. However, these ‘prints’, whether applied directly or indirectly onto the fabric, basically impede the adequate breathability thereof. In short, they cancel out the breathability of the fabric in the area onto which they are applied.

With reference to FIGS. 1a and 1b, a thermoadhesive transfer for application onto a fabric or onto materials in general is of a type known per se, obtained by means of a silk-screen, lithographic or offset printing process and/or a combination of these or other printing techniques.

The thermoadhesive transfer basically comprises:
a base sheet 1 made of paper, polyester, or in short any release base that allows the product 2 to be transferred;
at least one layer of product 2, made of polyurethane or flock or other materials, containing graphic designs, lettering, decorations and logos deposited on the base sheet 1;
at least one thermoadhesive layer over the product layer 2 for application onto the fabric.

The thermoadhesive transfer is then applied onto a fabric (which may be of various types: natural, synthetic, elastic, etc.) for instance using a hot press transfer process.

The product 2 is basically transferred from the base sheet 1 to the fabric, or material in general, to which it is ‘fixed’ through the thermoadhesive.

If the fabric is of the breathable, technical or elastic type, or for use in sportswear applications, etc. it may be important to maintain its ‘breathability’ even on the surface covered by the transfer which, in some cases, may regard a large portion of the fabric, up to a much as 30%.

According to the current state of the art, the process used to manufacture breathable transfers consists of creating products provided with holes (indicated by number 3 in FIGS. 1a and 1b) on the surface. Said holes are obtained for example by means of a silk-screen printing process in which the printed product is not applied to the whole surface.

However this process has a number of drawbacks and inevitable limitations:
The diameter of the holes cannot be made as ‘small’ as may be desirable. Thus, depending on the type of transfer product that is used, it is not usually possible to create holes with a diameter of less than a certain size. Holes of a given size increase the overall transparency of the transfer with a subsequent loss of definition of the image, significantly reducing the communicative effect (of an advertisement for instance) of the actual image.
Some types of transfers consist of several layers of product. In the final top layer (of the product that has not yet been applied), the thermoadhesive layer is wider or thicker than the underlying layers. During application the adhesive tends to close the area of the holes thus cancelling out and/or obstructing the desired level of breathability.

### SUMMARY OF THE INVENTION

The purpose of the present invention is to overcome all the drawbacks described above with a process for manufacturing a breathable thermoadhesive transfer, for instance for application onto a fabric, or onto materials in general, and the relative breathable thermoadhesive transfer that is obtained, so as to allow holes of any size, any shape, and any geometry, including variable geometry, to be created, and so as to guarantee breathability.

The present invention relates to a process for manufacturing a breathable thermoadhesive transfer, suitable for application onto a fabric or onto other materials, said thermoadhesive transfer comprising a base sheet, at least a layer of transfer product, and at least a layer of thermoadhesive material, characterized in that a step of processing using laser technology to create holes in said thermoadhesive transfer is carried out, before the application onto the fabric.

In particular, the present invention relates to a process for manufacturing a breathable thermoadhesive transfer, for instance for application onto a fabric, or onto materials in general, and the relative breathable thermoadhesive transfer that is obtained, as described more fully in the claims, which are an integral part of this description.

### BRIEF DESCRIPTION OF THE DRAWINGS

Further characteristics and advantages of this invention will become clear from the following detailed description of a preferred embodiment thereof, with the help of the drawings attached hereto, which are merely illustrative and not limitative, in which:

FIGS. 1a and 1b are views respectively from the top and of a side cross-section of a preferred embodiment of a thermoadhesive transfer with holes according to the prior art;

FIGS. 2a, 2b are views respectively from the top and of a side cross-section of preferred embodiments of a thermoadhesive transfer with holes obtained by means of the process according to the present invention;

FIG. 3 shows a side cross-section of an embodiment of a thermoadhesive transfer having a surface of variable depth.

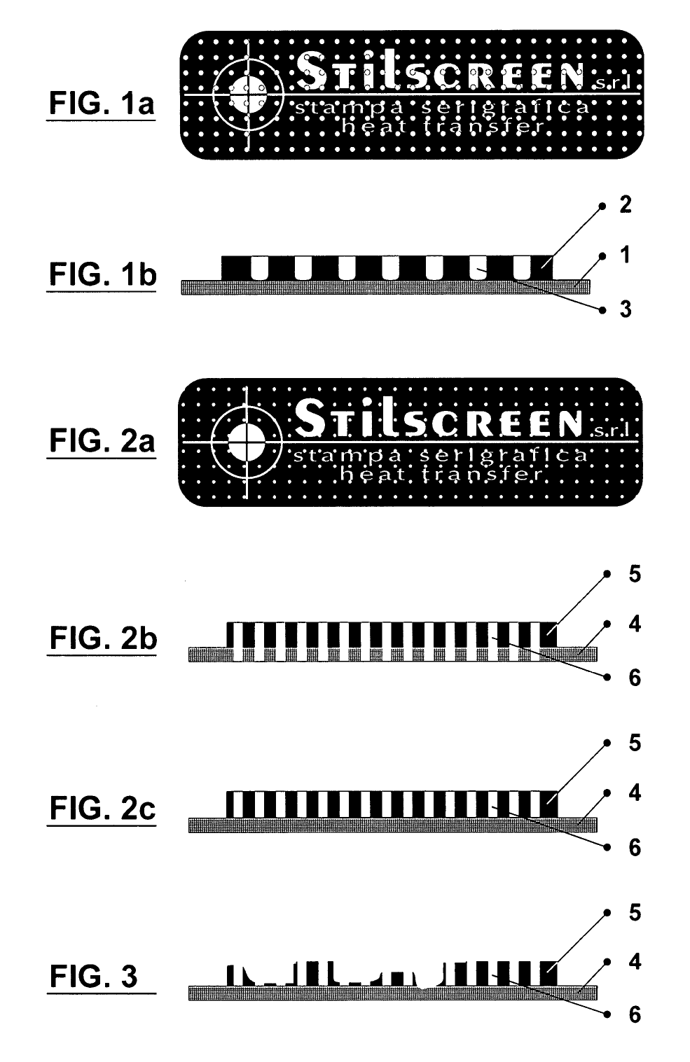

In the drawings the same numbers are used to indicate the same elements.

### DESCRIPTION OF THE PREFERRED EMBODIMENT

According to the main aspect of the present invention, a step of processing using laser technology is introduced in order to create the holes in the thermoadhesive transfer.

Firstly the thermoadhesive transfer is manufactured using a conventional process, for instance silk-screen printing without holes, so as to obtain the desired image on the transfer.

A laser is then used to make holes in the thermoadhesive transfer before applying it to the fabric.

Finally, the thermoadhesive transfer is transferred to the fabric using a process known in the art.

The use of laser technology makes it possible to create holes of any diameter, even a diameter as small as desirable, and of any shape, even not round, for instance slits, at any distance from one another, even at variable distances on different areas of the thermoadhesive transfer.

This method overcomes the problem of the readability of the image on the thermoadhesive transfer, in that the smaller the diameter of the holes the more the transparency in the area comprising the holes can be reduced, and the better the definition and communicative effect of the image.

It is possible to selectively vary the size and distance between the holes on the surface of the thermoadhesive transfer.

By using the laser technology, the width of the holes is constant throughout the entire depth of the thermoadhesive transfer, optionally including the base sheet layer. The laser creates an initial heat seal effect on the edge of the holes in correspondence with the adhesive, preventing any ‘re-closing’ of the holes; the latter is a phenomenon that occurs when using the methods known in the art, due to the adhesive being transferred onto the fabric during the subsequent step of hot application. By applying the invention the adhesive remains confined to the areas without holes even after application to the fabric.

With reference to FIG. 2b, the drawing illustrates the base sheet 4, the top layer 5 of transfer product, and the holes 6 made using the laser, that pass through the entire thickness of the thermoadhesive transfer, including the base sheet.

In the variant embodiment of FIG. 2c the base sheet 4 is not holed.

Furthermore, the use of laser technology makes it possible to achieve further significant visual effects. The surface of the thermoadhesive transfer can be cut to varying depths (see FIG. 3), and/or on different levels, eliminating portions thereof, to create image effects with variable depths.

A non-limitative example of a conventional laser machine for thermoadhesive transfer processing comprises a CO₂ laser source, with a power of between 100-200 Watt, electronically controlled by means of a computer provided with a monitor and operating software for cutting/marking the thermoadhesive transfer. The machine also comprises a three-axis galvanometric scanner with polar guide of the laser beam, focusing and adjustable cutting depth, and an external graphics station for defining the specific geometry of the holes in the thermoadhesive transfer.

The programming of the laser machine to obtain the desired hole geometry and cutting depths is performed in an usual way.

It will be apparent to the person skilled in the art that other alternative and equivalent embodiments of the invention can be conceived and reduced to practice without departing from the true spirit of the invention.

From the description set forth above it will be possible for the person skilled in the art to embody the invention without introducing any further construction details.

What is claimed is:

1. A process for manufacturing a breathable thermoadhesive transfer, suitable for application onto a fabric or onto other materials, said thermoadhesive transfer comprising a base sheet, at least a layer of transfer product, and at least a layer of thermoadhesive material, wherein said process comprises using laser technology to create holes in said thermoadhesive transfer, before the application onto the fabric.

2. A process according to claim 1, wherein said holes are created in said at least a layer of transfer product and at least a layer of thermoadhesive material.

3. A process according to claim 2, wherein said holes are created also in said base sheet.

4. A process according to claim 2, wherein said holes have a constant width throughout the depth of said thermoadhesive transfer.

5. A process according to claim 3, wherein said holes have a constant width throughout the depth of said thermoadhesive transfer.

6. A process according to claim 1, wherein said step of processing using laser technology creates holes of any diameter, any shape, for instance slits, at any distance from one another, even at variable distances on different areas of said thermoadhesive transfer.

7. A process according to claim 1, wherein it also comprises a step in which the surface of said thermoadhesive transfer is cut, using laser technology, to varying depths, even through the entire thickness, eliminating portions thereof.

8. A breathable thermoadhesive transfer obtained by means of a process according to claim 1.

9. A breathable thermoadhesive transfer obtained by means of a process according to claim 2.

10. A breathable thermoadhesive transfer obtained by means of a process according to claim 3.

11. A breathable thermoadhesive transfer obtained by means of a process according to claim 4.

12. A breathable thermoadhesive transfer obtained by means of a process according to claim 5.

13. A breathable thermoadhesive transfer obtained by means of a process according to claim 6.

14. A breathable thermoadhesive transfer obtained by means of a process according to claim 7.
